(19) United States
(12) Patent Application Publication
(10) Pub. No.: US 2006/0126555 A1
(43) Pub. Date: Jun. 15, 2006

(54) System for load balance on access points over WLAN and method therefor

(75) Inventors: Hao-Li Wang, Taipei City (TW); Jyh-Chang Ueng, Sinfong Township (TW)

Correspondence Address: BACON & THOMAS, PLLC, 625 SLATERS LANE, FOURTH FLOOR, ALEXANDRIA, VA, 22314, US

(73) Assignee: Institute for Information Industry, Taipei City (TW)

(21) Appl. No.: 11/028,592

(22) Filed: Jan. 5, 2005

(30) Foreign Application Priority Data
Nov. 23, 2004 (TW) 093135969

(51) Int. Cl. H04Q 7/00

(52) U.S. Cl. 370/328

(57) ABSTRACT

Provided is a system for load balance on APs over a WLAN and method therefor. The system comprises a WLAN switch in an ESS; a plurality of APs in the ESS, each AP having a BSS wherein at least two BSSs overlap; and a plurality of mobile stations in the BSSs wherein each of the mobile stations located in the overlaid BSSs is adapted to choose one AP for connection from the APs capable of connecting thereto. Each mobile station is adapted to detect each connected AP and record the same, in response to connection to the AP the mobile station is adapted to report information about the connected AP to the WLAN switch via the connected AP, and the WLAN switch is adapted to cause any two APs to have a substantially equal number of the connected mobile stations by adjustment.

### BACKGROUND OF THE INVENTION

1. Field of the Invention

The present invention relates to a wireless local area network (WLAN) and, more particularly, to a system for balancing load on an access points (AP) over a WLAN and a method therefor.

2. Description of Related Art

The existing IEEE 802.11 standard for WLANs was published in 1997. In the IEEE 802.11 standard, physical layer (PHY) and medium access control (MAC) operations are defined. As shown in the WLAN system of FIG. 1, a plurality of APs A, B, C, and D are in an extended service set (ESS) of a WLAN switch 11. Each AP has its own basic service set (BSS) and some BSSs overlap. As such, some mobile stations 1 to 8 in the overlaid BSSs may associate one of four APs A, B, C, and D. Typically, a mobile station automatically associates with an AP with the strongest signal intensity. For example, mobile station 1 associates with AP A, mobile stations 2, 3 and 4 associates with AP B, mobile station 5 associates with AP C, and mobile stations 6, 7 and 8 associates with AP D.

Load imbalance often occurs in a crowded area. For example, many people attend an exhibition or sports event and carry a mobile communication device (i.e., mobile station). As such, connections to a small number of APs (e.g., APs B and D) are possible. That is, such APs have a heavy load. This is because, as stated above, a mobile station is adapted to automatically connect to an AP having the strongest signal intensity (e.g., one AP nearest the mobile station). The overloaded APs are thus unable to connect to any mobile stations, thus causing a bottleneck. Moreover, such an overload can lower quality of service.

The prior art thus suffered from several disadvantages. For example, load imbalance tends to occur if a free connection of a mobile station to an AP having the strongest signal intensity is allowed. In turn, load imbalance will lower availability of ESS and thus AP resources are wasted. Even worse, overload (i.e., load concentrated on a small number of APs) may limit flow, resulting in a lowering of quality of service. Hence, a need for improvement exists.

### SUMMARY OF THE INVENTION

An object of the present invention is to provide a system for load balance on APs over a WLAN and method therefor such that the load can be evenly carried on all available APs, thereby effectively utilizing AP resources, increasing availability of ESS, and thus increasing quality of service.

One aspect of the present invention is to provide a system for load balance over a WLAN comprising a WLAN switch having an ESS; a plurality of APs in the ESS, each AP having a BSS wherein at least two BSSs overlap; and a plurality of mobile stations in the BSSs wherein each of the mobile stations located in the overlaid BSSs is adapted to choose one AP for connection from the APs capable of connecting thereto, wherein each mobile station is adapted to detect each connected AP and record the same, in response to connecting to the AP the mobile station is adapted to report information about the connected AP to the WLAN switch via the connected AP, and the WLAN switch is adapted to cause any two APs to have a substantially equal number of the connected mobile stations by adjustment.

Another aspect of the present invention is to provide, in a WLAN system including a WLAN switch having an ESS, a plurality of APs in the ESS, each AP having a BSS wherein at least two BSSs overlap, and a plurality of mobile stations in the BSSs wherein each of the mobile stations located in the overlaid BSSs is adapted to choose one AP for connection from the APs capable of connecting thereto, a method for load balance on the APs, comprising (a) causing each mobile station to detect each connected AP and record the same; (b) in response to connecting to the AP causing the mobile station to report information about the connected AP to the connected AP; (c) causing the connected AP to send the report information to the WLAN switch; and (d) causing the WLAN switch to command any two APs to have a substantially equal number of the connected mobile stations by adjustment.

Other objects, advantages, and novel features of the invention will become more apparent from the detailed description when taken in conjunction with the accompanying drawings.

### BRIEF DESCRIPTION OF THE DRAWINGS

FIG. 1 presents schematically the connection of a WLAN switch to a plurality of mobile stations via APs over a WLAN according to prior art;

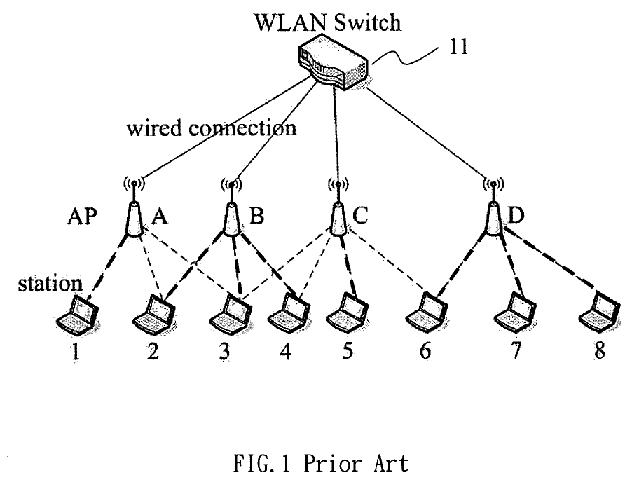

FIG. 2 presents schematically the connection of a WLAN switch to a plurality of mobile stations via APs over a WLAN prior to performing a load balance method according to the invention;

FIG. 3 presents schematically a graph of APs having old connections and new connections obtained by performing the load balance method according to the invention for illustrating a network flow model; and

FIG. 4 is a graph similar to FIG. 3 with new connections obtained by performing a maximum flow algorithm according to the invention.

### DETAILED DESCRIPTION OF THE PREFERRED EMBODIMENT

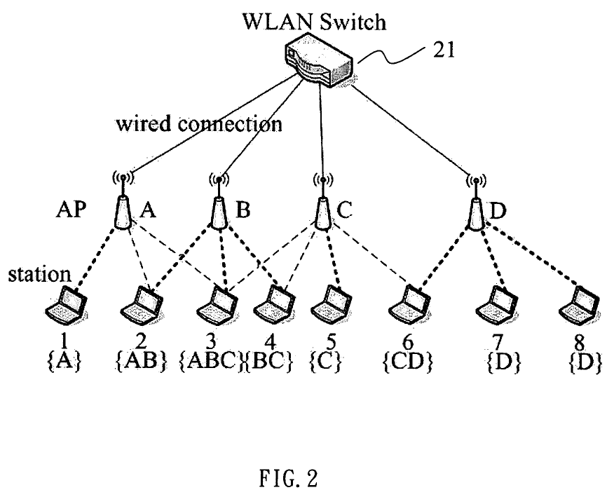

With reference to FIG. 2, there is shown a system for load balance on APs over a WLAN in accordance with the invention. As shown in the WLAN system, a plurality of APs A, B, C, and D are in an ESS of a WLAN switch 21. Each AP has its own BSS, and some BSSs overlap. As such, some of the mobile stations 1 to 8 in the overlaid BSSs may have a chance to choose one AP from at least two of APs A, B, C, and D for connection by association. A wired connection from the WLAN switch 21 to APs A, B, C, and D is implemented. The APs A, B, C, and D in turn are connected to mobile stations 1 to 8 by wireless connection.

First, each one of mobile stations 1 to 8 is adapted to detect a connected AP (i.e., one capable of receiving signal transmitted from the mobile station) and record the same. It is assumed that mobile stations 1, 2 and 3 are in the BSS of AP A, mobile stations 2, 3 and 4 are in the BSS of AP B, mobile stations 4, 5 and 6 are in the BSS of AP C, and mobile stations 6, 7 and 8 are in the BSS of AP D. Thus, it is recorded that mobile station 1 is adapted to connect to AP A, mobile station 2 is adapted to connect to APs A and B, mobile station 3 is adapted to connect to APs A, B, and C, mobile station 4 is adapted to connect to APs B and C, mobile station 5 is adapted to connect to AP C, mobile station 6 is adapted to connect to APs C and D, mobile station 7 is adapted to connect to AP D, and mobile station 8 is adapted to connect to AP D.

In the existing 802.11 standard, initially a mobile station may try to connect to the nearest AP having the strongest signal intensity by association. As shown, mobile station 1 is connected to AP A, mobile stations 2, 3, and 4 are connected to AP B, mobile station 5 is connected to AP C, and mobile stations 6, 7, and 8 are connected to AP D. It is seen that the load on the APs is not balanced. Preferably, two mobile stations are connected to one AP, i.e., eight mobile stations are averagely carried on four APs.

After connection, an AP table is created based on the recorded AP by one of mobile stations 1 to 8 connected to the AP and the table is reported to the AP. For example, mobile station 1 reports to AP A that {A} is contained in its AP table, mobile station 2 reports to AP B that {A,B} is contained in its AP table, mobile station 3 reports to AP B that {A,B,C} is contained in its AP table, mobile station 4 reports to AP B that {B,C} is contained in its AP table, mobile station 5 reports to AP C that {C} is contained in its AP table, mobile station 6 reports to AP D that {C,D} is contained in its AP table, mobile station 7 reports to AP D that {D} is contained in its AP table, and mobile station 8 reports to AP D that {D} is contained in its AP table.

After collecting the AP tables, each of APs A, B, C, and D arranges them prior to reporting to WLAN switch 21. In a report to WLAN switch 21 prepared by AP A, one {A} is listed. In a report to WLAN switch 21 prepared by AP B, one {A,B}, one {B,C}, and one {A,B,C} are listed. In a report to WLAN switch 21 prepared by AP C, one {C} is listed. In a report to WLAN switch 21 prepared by AP D, one {C,D} and two {D} are listed.

WLAN switch 21 then arranges the reports and obtains a result of mobile stations connected to APs. In the embodiment, WLAN switch finds that there is one connected {A}, one connected {AB}, one connected {BC}, one connected {ABC}, one connected {C}, one connected {CD}, and two connected {D}s. Based on the result the WLAN switch adjusts the mobile stations connected to an AP in which each of the APs having the number of connected mobile stations larger than an average (i.e., larger than an integral portion of a value obtained by dividing the number of total mobile stations by the number of total APs) is required to disconnect the excess mobile station(s) (i.e., obtained by subtracting the average from the number of mobile stations connected to the AP) and the disconnected one(s) is (are) adapted to connect to a corresponding one of the APs having the number of connected mobile stations less than the average. Next, each AP having excess connected mobile stations issues an associate.request to a corresponding AP such that an adjustment can be made immediately. As a result, load balance is obtained.

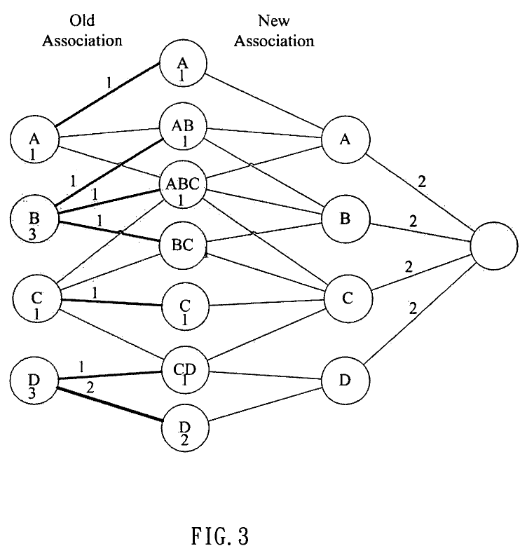

For obtaining an optimum load balance, the WLAN switch converts the result into a network flow graph as shown in FIG. 3. In a left portion, four nodes represent four original APs. In an intermediate portion, seven nodes represent seven AP tables. In a right portion, four nodes represent four adjusted (i.e., new) APs. In the embodiment, a balance load means that each AP has two connected mobile stations. The number of two is obtained by dividing the number of total mobile stations by the number of total APs and discarding its decimal portion. As such, each new AP is set to be able to connect to two mobile stations. A maximum flow algorithm is employed to calculate a flow passing the seven nodes in the intermediate portion by considering the above given conditions. The flow eventually meets at the rightmost node. The maximum flow algorithm is chosen from Ford and Fulkerson's algorithm, the Push-Relabel method, the Scaling minimum-cost flow algorithm, or Karzanov's algorithm.

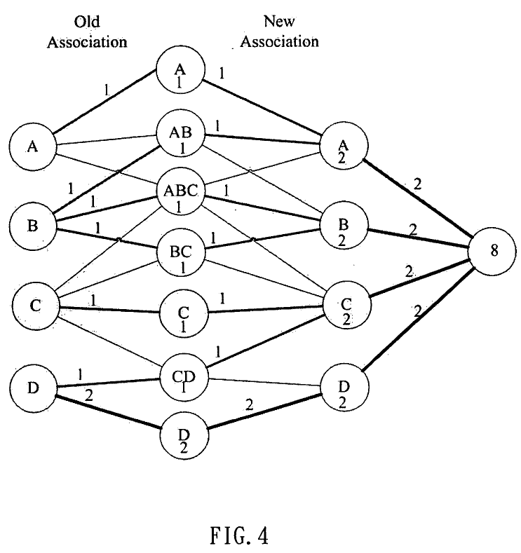

A result obtained by the maximum flow algorithm is a new association as shown in FIG. 4. In the new association each AP has two connected mobile stations. It is also found that two mobile stations are changed in their connections. That is, mobile station 2 has its connected AP B (i.e., AP table {AB}) changed to AP A. Also, mobile station 6 has its connected AP D (i.e., AP table {CD}) changed to AP C.

In brief, the invention comprises the steps of reporting information about APs connected to mobile stations to the WLAN switch, and enabling the WLAN switch to adjust the number of mobile stations connected to the APs by utilizing the information. As an end, a balance load is obtained. The invention thus has the following advantages. The AP resource can be effectively utilized. The availability of the WLAN system can be increased since a load balance is obtained. Finally, a load is averagely carried on all available APs (i.e., no flow concentration), thus increasing quality of service.

While the invention herein disclosed has been described by means of specific embodiments, numerous modifications and variations could be made thereto by those skilled in the art without departing from the scope and spirit of the invention set forth in the claims.

What is claimed is:

1. A system for load balance over a WLAN comprising:
a WLAN switch having an ESS;
a plurality of APs in the ESS, each AP having a BSS wherein at least two BSSs overlap; and
a plurality of mobile stations in the BSSs wherein each of the mobile stations located in the overlaid BSSs is adapted to choose one AP for connection from the APs capable of connecting thereto,
wherein each mobile station is adapted to detect each connected AP and record the same, in response to connecting to the AP the mobile station is adapted to report information about the connected AP to the WLAN switch via the connected AP, and the WLAN switch is adapted to cause any two APs to have a substantially equal number of the connected mobile stations by adjustment.

2. The system of claim 1, wherein each AP having the number of the connected mobile stations larger than a predetermined value is adapted to disconnect excess at least one mobile station and the disconnected at least one mobile station is adapted to connect to a corresponding one of the APs having the number of the connected mobile stations less than the predetermined value.

3. The system of claim 2, wherein the predetermined value is obtained by dividing the number of the mobile stations by the number of the APs with a decimal portion of the predetermined value being discarded.

4. The system of claim 1, wherein the WLAN switch employs a maximum flow algorithm to obtain an adjusted association.

5. The system of claim 1, wherein the WLAN switch is adapted to send information about an association to be adjusted to each AP having excess at least one mobile station such that the informed AP is adapted to make an adjustment accordingly.

6. In a WLAN system including a WLAN switch having an ESS, a plurality of APs in the ESS, each AP having a BSS wherein at least two BSSs overlap, and a plurality of mobile stations in the BSSs wherein each of the mobile stations located in the overlaid BSSs is adapted to choose one AP for connection from the APs capable of connecting thereto, a method for load balance on the APs, comprising the steps of:
(a) causing each mobile station to detect each connected AP and record the same;
(b) in response to connecting to the AP causing the mobile station to report information about the connected AP to the connected AP;
(c) causing the connected AP to send the report information to the WLAN switch; and
(d) causing the WLAN switch to command any two APs to have a substantially equal number of the connected mobile stations by adjustment.

7. The method of claim 6, wherein in the step (d) each AP having the number of the connected mobile stations larger than a predetermined value is adapted to disconnect excess at least one mobile station and the disconnected at least one mobile station is adapted to connect to a corresponding one of the APs having the number of the connected mobile stations less than the predetermined value.

8. The method of claim 7, wherein the predetermined value is obtained by dividing the number of the mobile stations by the number of the APs with a decimal portion of the predetermined value being discarded.

9. The method of claim 6, wherein in the step (d) the WLAN switch employs a maximum flow algorithm to obtain an adjusted association.

10. The method of claim 6, further comprising the step of:
(e) causing the WLAN switch to send information about an association to be adjusted to each AP having excess at least one mobile station such that the informed AP is adapted to make an adjustment accordingly.
